(19) United States
(12) Patent Application Publication
(10) Pub. No.: US 2016/0080166 A1
(43) Pub. Date: Mar. 17, 2016

(54) METHOD AND SYSTEM FOR FACILITATING AUTOMATION

(71) Applicant: Cassia Networks, San Jose, CA (US)

(72) Inventors: Tai Seng Chen, San Jose, CA (US); Hongyi Zeng, Foster City, CA (US); Fuyong Zhao, San Jose, CA (US)

(21) Appl. No.: 14/858,607

(22) Filed: Sep. 18, 2015

Related U.S. Application Data
(63) Continuation-in-part of application No. 14/852,372, filed on Sep. 11, 2015.
Application No. 14/852,372 is a continuation-in-part of application No. 62/048,870, filed on Sep. 11, 2014.
(60) Provisional application No. 62/052,048, filed on Sep. 18, 2014.

(51) Int. Cl. H04L 12/28; G05B 15/02

(52) U.S. Cl. CPC H04L 12/2816; G05B 15/02

(57) ABSTRACT

A system for facilitating automation is disclosed. The system includes a user interface configured for receiving at least one rule from a user, a rule of the at least one rule comprises at least one condition and at least one action, the at least one condition is based on at least one state of at least one electronic device of a plurality of electronic devices, an electronic device of the plurality of electronic devices comprises at least one of a sensor and an actuator, the at least one action comprises at least one change in a state of an actuator comprised in an electronic device of the plurality of electronic devices. The system includes a control hub configured for receiving the at least one state of the at least one electronic device and performing the at least one action based on a result of evaluating the at least one condition.

### CROSS-REFERENCE TO RELATED APPLICATIONS

This application claims benefit of U.S. provisional patent application No. 62/052,048, filed on Sep. 18, 2014, and is a continuation in part of U.S. utility patent application Ser. No. 14/852,372 filed Sep. 11, 2015 which claims benefit of U.S. provisional patent application No. 62/048,870 filed Sep. 11, 2014.

### FIELD OF THE INVENTION

Generally, the disclosure relates to a system for facilitating automation. More specifically, the disclosure relates to a controller hub for home networks.

### BACKGROUND

In the last decade, various mobile devices, such as smart phones, tablet computers, phablets, and wearable devices have become ubiquitous. This trend is expected to continue. More devices that humans use in day-to-day life are set to become internet-enabled smart devices. For example, smart microwave ovens, smart refrigerators, smart door locks, smart garage doors and even smart pans used to cook food in kitchen

For most of these devices, the product manufacturers also provide a smartphone application. However, developing and maintaining these applications is difficult for the product manufacturers. Moreover, it is difficult for users to install and use different applications for different appliances. Yet further, the current applications restrict the automation functionality to the specific devices themselves.

Some services are available that allow users to customize very simple tasks for multiple smart devices. However, there is a need for a generalized system to tackle significantly more complex configurations; for example by executing a chained Boolean operator that creates multiple triggers that cause multiple actions.

### SUMMARY

A system for facilitating automation is disclosed. The system includes a user interface configured for receiving at least one rule from a user, wherein a rule of the at least one rule comprises at least one condition and at least one action, wherein the at least one condition is based on at least one state of at least one electronic device of a plurality of electronic devices, wherein an electronic device of the plurality of electronic devices comprises at least one of a sensor and an actuator, wherein the at least one action comprises at least one change in a state of an actuator comprised in an electronic device of the plurality of electronic devices. The system further includes a control hub configured for receiving the at least one state of the at least one electronic device, wherein the at least one electronic device is configured for communicating with the control hub; and performing the at least one action based on a result of evaluating the at least one condition.

In another embodiment, a method of facilitating automation is disclosed. The method includes presenting, with a processor, a user interface configured for receiving at least one rule from a user, wherein a rule of the at least one rule comprises at least one condition and at least one action, wherein the at least one condition is based on at least one state of at least one electronic device of a plurality of electronic devices, wherein an electronic device of the plurality of electronic devices comprises at least one of a sensor and an actuator, wherein the at least one action comprises at least one change in a state of an actuator comprised in an electronic device of the plurality of electronic devices. Thereafter, the method includes receiving, with the processor, the at least one state of the at least one electronic device. Finally the method includes performing, with the processor, the at least one action based on a result of evaluating the at least one condition.

In a further embodiment, a set of smart electronic devices and the control hub form a network and allow them to communicate with each other and provide actionable advice to humans.

In a yet further embodiment, the control hub includes a suite of learning algorithms and filtering algorithms to process data received from electronic devices.

### BRIEF DESCRIPTION OF DRAWINGS

FIG. 1 illustrates an environment in which an embodiment of the present invention operates.

FIG. 2 is a block diagram of a system for facilitating automation, in accordance with an embodiment.

FIG. 3 is a flowchart of a method for facilitating automation, in accordance with an embodiment.

FIG. 4 illustrates the method for facilitating automation, in accordance with an exemplary embodiment.

FIG. 5 illustrates an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

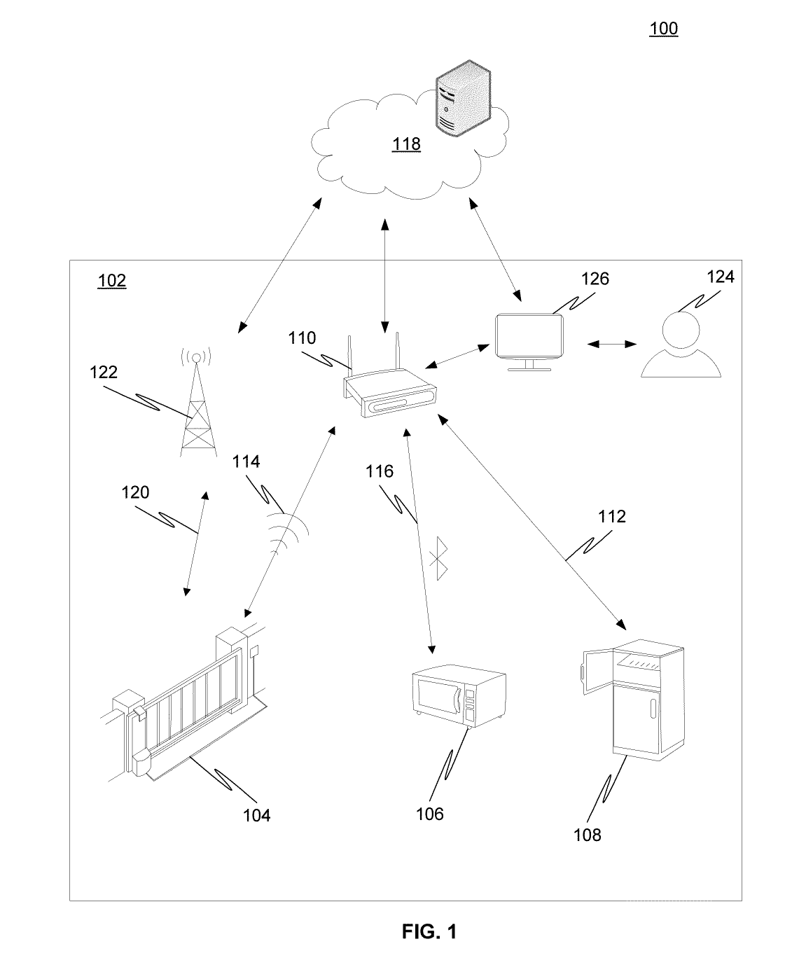

The present invention will be further illustrated with examples below. Referring first to FIG. 1 illustrating an environment 100 in which an embodiment of the present disclosure operates.

The environment 100 includes a home 102, which includes multiple electronic devices including an electronic door 104, a microwave oven 106 and a refrigerator 108. Further, the electronic devices may be small single-function consumer devices designed for portability and convenience. For example, the electronic device may be one of a wearable medical device configured for monitoring a physiological parameter of a user, a wearable medical device configured for detecting a falling state of a user or a thermostat to measure temperature in a room. Each of the electronic devices 104-108 has some associated states and actions. For example, a thermostat has a “temperature” state and an “on/off” action. A state may be represented as a number, or a Boolean value. An action is a method that can optionally take arguments.

Further, each of the electronic devices 104-108 is enabled to communicate with a control hub 110. The control hub 110 may be an electronic device capable of receiving states from the electronic devices 104-108, storing the received states and rules, performing analysis on the states based on the rules and sending instructions to perform one or more actions based on the rules. Specifically, the electronic devices 104-108 send states of their one or more sensors to the control hub 110. Further, the electronic devices 104-108 are configured to perform actions based on instructions received from the control hub 110.

The control hub may connect to the electronic devices 104-108 via a wired connection or a wireless connection. For example, the refrigerator 108 is connected to the control hub 110 via a wired connection 112. One the other hand, the microwave oven 106 and the electronic door 104 are connected to the control hub 110 via wireless connections. Further, the wireless connections may be established using one of, but limited to, Wi-Fi, Bluetooth, Zigbee RFID, NFC, 3G/2G, and Infrared (IR). For example, a wireless connection 114 between the electronic door 104 and the control hub 110 is a Wi-Fi connection. A wireless connection 116 between the microwave oven 106 and the control hub 110 is a Bluetooth connection. The control hub 110 may be a class 1 or class 2 Bluetooth device, which provides it a range of 100 m and 10 m respectively. Alternatively, the Bluetooth range extenders may be deployed at various places in the home 102. The Bluetooth range extenders help electronic devices located far away from the control hub 110 to communicate with the control hub 102. Similarly, any other suitable technology may be used to extend the Bluetooth range to reach all corners of a conventional ranch style wood frame US house.

Further, the control hub 110 may be connected to a cloud server 118. The control hub 110 may send data comprising the states of the electronic devices 104-108 to the cloud server 118. Further, the data flow may be bidirectional, wherein software updates, test settings and setup conditions may be downloaded from the cloud server 118 at the control hub 110.

In an alternate embodiment, the control hub may be a software application implemented in the cloud server 118. The control hub software application is configured to receive the states from the electronic devices 104-108, store the received states and rules, perform analysis on the states based on the rules and send instructions to perform one or more actions based on the rules. The electronic door 104 may communicate with the control hub software application using a cell phone connection 120 via one or more cell phone towers 122.

A homeowner 124 is able to configure the control hub 110 using a user interface on a computer 126. The user interface may be provided by the control hub 110.

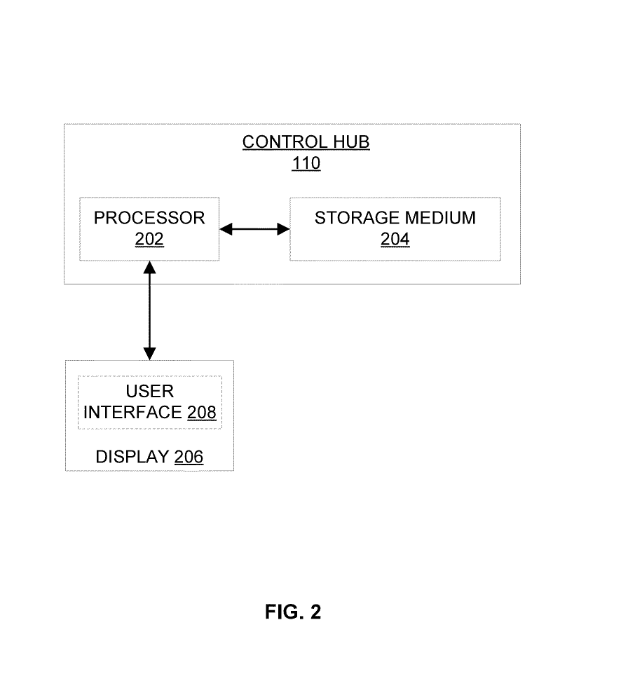

Now, referring to FIG. 2, the control hub 110 for facilitating automation is illustrated in accordance with an embodiment. The control hub 110 includes one or more processors (for example, a processor 202) and a storage medium (e.g., a memory) 204. The control hub may also be connected to a display 206. The display 206 may be a display present on the control hub or it may be the display of the computer 126.

In particular, the processor 202 is configured to process states received from multiple electronic devices (for example, the electronic devices 104-108). The processor 202 may be configured to communicate with the multiple electronic devices 104-108 with REST API. The processor 202 may transmit HTTP GET requests to the multiple electronic devices 104-108 in order to receive the state of the multiple electronic devices 104-108. Further, the processor 202 may accept HTTP POST requests from the multiple electronic devices 104-108. After processing the received states, the processor 202 may POST actions to the multiple electronic devices 104-108 based on pre-defined rules. The pre-defined rules may be provided by one or more of the homeowner 124, the manufacturer of the control hub 110 and the manufacturers of the multiple electronic devices 104-108. Further, the processor 202 and multiple electronic devices 104-108 may exchange messages using JSON format.

The homeowner 124 interacts with the control hub 110 via a user interface 208 accessible to the users via the display 206. The user interface 208 may also transmit HTTP GET requests to one of the multiple electronic devices 104-108 and the control hub 110 in order to receive the states of the multiple electronic devices 104-108. The homeowner 124 may use the user interface 208 to define rules for selected states and the corresponding desired actions. The user interface 208 is further configured to allow the user to provide rules without any coding. Based on the inputs from the homeowner 124, the user interface 208 generates rules in JSON and stores them in a storage medium, for example, the storage medium 204.

The storage medium 204 stores instructions that, when executed by one or more processors 202, cause one or more processors 202 to facilitate automation in accordance with various embodiments. In an embodiment, the storage medium 204 may be a computer readable medium. Further, the storage medium 204 stores the states received from the multiple electronic devices 104-108 and the pre-defined rules. The states of the multiple electronic devices 104-108 may be obtained at a plurality of time instants to form a time-series.

The storage medium 204 may further store learning algorithms including, but not limited to, algorithms for pattern detection and recognition; association and classification (Naive Bayes classification and Supporting Vector Machine classification); regression (linear regression and logistic regression) and time series analysis. The learning algorithms when executed by one or more processors 202 causes the one or more processors 202 to customize rules based on one or more of the lifestyle of the homeowner 124, minimize the costs and maximizing the safety.

Yet further, the storage medium 204 may further store filtering algorithms including, but not limited to, non-linear median filtering, low pass exponential smoothing filtering, moving average filtering and moving average filtering with non-overlapping window. The filtering algorithms when executed by one or more processors 202 causes the one or more processors 202 to configure rules for multiple electronic devices 104-108 for a second time period based on the states in a first time period.

For example, a combination of heuristics and pattern recognition based rules for a smart thermostat helps in creating a weekly schedule to help homeowners save energy. More specifically, when the control hub 110 first powers up, the first weekly temperature set point schedule is the factory pre-loaded default schedule. The factory set schedule could be obtained by fine-tuning through off-line learning. The factory set schedule may be modified in an initial schedule setup screen in which the homeowner 124 can input data for bedtime for weekend and weeknights, temperature set points for bedtime, daytime and “no one home” time. The control hub 110 constructs the first weeks temperature set point schedule. During the first week, this schedule can be overridden by manual set point changes by the homeowner 124 subject to minimum/maximum constraints to prevent inadvertent human entry error. The temperature set point so entered is put into next weeks schedule.

One or both of the control hub 110 and the user interface 208 log all the manual set point changes made by the homeowner 124. The manually entered data plus the previous data is manipulated using learning and filtering algorithms to make the next weeks schedule. At first, every adjustment the homeowner 124 makes is incorporated into the schedule. Over time, the thermostat will incorporate time-weighted patterns of changes. Temperature set points for every hour of each day of the week will form a time series. The pattern is obtained by applying a simple first order exponential filter to the time series that gives more weight to more recent changes.

Essentially, there are two temperature set point schedules, “this week's schedule” and “next week's schedule”. “This week's schedule” can be modified by manual adjustments by the homeowner 124 and adjustments made by “no one home” temperature set points when “no one home time” varies. “The next week's schedule” is constructed from the exponentially smoothed time series. Thus over time the control hub 110 produces a weekly temperature set point schedule to give the homeowner 124 what they want on each hour of each day of each week. This automatically generated weekly schedule is further enhanced by a concept called the “no one home” mode.

Further, low cost motion detectors may be installed in various rooms or in high foot traffic areas. The motion detectors and the presence sensors worn by homeowners can be used to predict “no one home” condition. Again, the desired temperature set point for the “no one home” condition is factory preset and could be set as low as 60 degrees Fahrenheit but it can be changed by the home owner(s) using the thermostat's touch screen. Much of the energy savings come from the “no one home” feature.

Further energy savings can be achieved using re-enforcement training, where good user behavior is rewarded with documented monthly energy savings report that compares four key metrics, average bedtime temperature, “no one home” temperature and rest of the time temperature, and total energy consumption this month versus last month. Therefore, homeowners may be encouraged to nudge down the key temperature set points and watch their monthly utility bill go down.

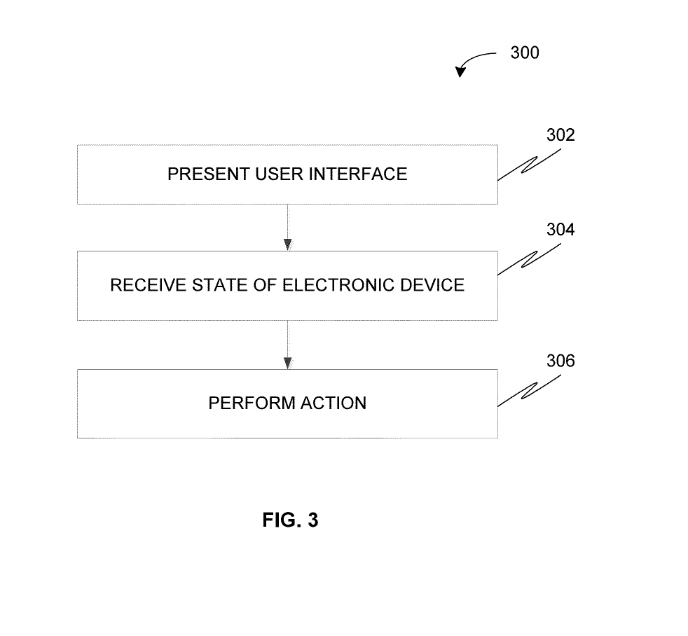

FIG. 3 illustrates a flowchart of a method 300 for facilitating automation, in accordance with an embodiment. At step 302, the user interface 208 is presented to the homeowner 124. The user interface 208 allows the homeowner 123 to provide one or more rules. Each rule includes one or more conditions and one or more actions. The electronic devices 104-108 include one or more sensors and actuators. The one or more conditions are based on one or more states of the electronic devices 104-108. For example, for a thermostat, a condition may be “thermostat.temperature>30”. Further, two or more conditions may be chained together using Boolean operators with AND, OR, NOT operators. For example, a first condition “thermostat.temperature>30” and a second condition (window.open==true) may be chained together as “thermostat.temperature>30 or (window.open==true)”. A logic library may be used to use available Boolean operators to create valid rules.

The one or more actions include one or more changes in a state of an actuator of an electronic device in the electronic devices 104-108.

A rule is a condition plus one or more actions. For example, two conditions “(thermostat.temperature>30)” and “(airconditioner.on==false)” may be combined together to form a rule, such as, “IF (thermostat.temperature>30) AND (airconditioner.on==false) THEN airconditioner.start ( )”. The action in this rule is “airconditioner.start ( )”.

Further, the control hub 110 may dynamically discover all smart electronic devices in the range of the control hub 110. Thereafter, the user interface 208 may request the homeowner 124 to pair the smart electronic devices discovered by the control hub 110 with the control hub 110. Thereafter, the control hub 110 automatically maintains connection with the paired smart electronic devices. Further, the homeowner 124 may define rules for the newly discovered electronic devices using the user interface 208. The user interface 208 also ensures that all rules are valid. Thereafter, the control hub 110 enforces the rules as defined by the homeowner 124. Therefore, the rules enable the control hub to conduct deductive reasoning to trigger actions when some condition is met.

At step 304, the state of the one or more electronic devices 104-108 is received by the control hub 110. The control hub 110 may transmit a request to the one or more electronic devices in order to receive the state of the one or more electronic devices. In response to the request, the one or more electronic devices 104-108 send their states to the control hub 110.

Further, the control hub 110 identifies a set of actions based on analyzing the states of the electronic devices 104-108. Accordingly, the user interface 208 presents the identified set of actions to the homeowner 124 in order to enable the homeowner 124 to select the one or more actions from the identified set of actions. Yet further, the control hub 110 may automatically select some actions from the identified set of actions corresponding to the one or more conditions. For example, the homeowner 124 may be switching on the air conditioner everyday around 8 PM. Based on analysis of the time-series of states of the air conditioner, the control hub 110 may identify that the air conditioner is switched on at 8 PM every day. Therefore, it may automatically select an action to switch on the air conditioner, when the time is 8 PM. This allows the homeowner 124 to easily setup device-to-device autonomous action(s) customized to the preferred life style of the homeowner 124.

Thereafter, at step 306, the one or more actions based on a result of evaluating the one or more conditions are performed. An action is a method that can optionally take arguments. Actions are generated based on event or time. For example, a pre-defined rule may define an action to send a user-defined message, whenever a window is detected to be opened. In another example, if the homeowner 124 wears a presence sensor, then when the homeowner 124 leaves home, the absence of the homeowner 124 from home is detected. This sets in motion the “no one home” mode. Once this mode is activated, the thermostat of the homeowner 124 is turned down, the ionizer in the air purifier of the homeowner 124 is turned off, the garage door of the homeowner 124 is closed, cook top turned off, all the lights are turned off and the doors are locked.

The method 300 may go into active mode periodically (for example, every second) to pull the most recent states from one of the multiple electronic devices 104-108 and the control hub 110 and the JSON files generated by the user interface 208. The method 300 then identifies one or more actions to be performed based on the pulled information. Finally, the method 300 performs the identified one or more actions. If no action is identified, then the method 300 goes into sleep mode.

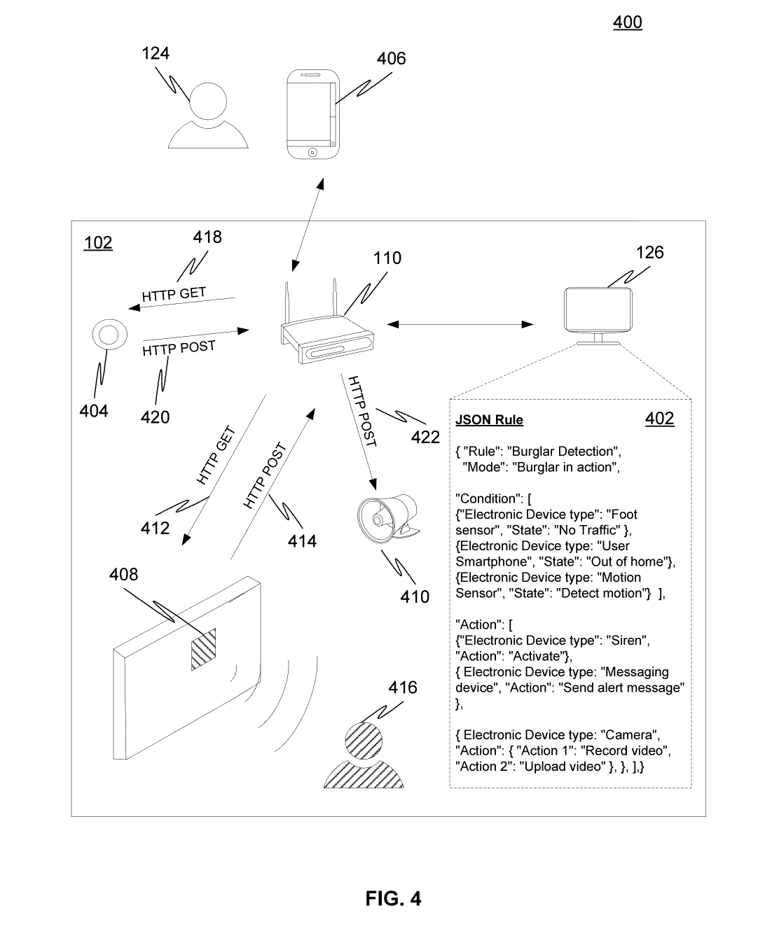

FIG. 4 illustrates an exemplary situation 400 in accordance with an embodiment. As shown, the homeowner 124 is outside the home 102. Before leaving home, the homeowner 124 used the user interface 208 on the computer 126 to define a rule to detect burglars and perform one or more actions. The rule defined by the homeowner 124 is stored by one or both of the user interface 208 and the control hub 110 in JSON format (refer, JSON rule 402).

The details of the JSON rule 402 are provided below:

{ “Rule”: “Burglar Detection”,
“Mode”: “Burglar in action”,
“Condition”: [
{“Electronic Device type”: “Foot sensor”, “State”: “No Traffic” },
{Electronic Device type: “User Smartphone”, “State”: “Out of home”},
{Electronic Device type: “Motion Sensor”, “State”: “Detect motion”} ],
“Action”: [
{“Electronic Device type”: “Siren”, “Action”: “Activate”},
{ Electronic Device type: “Messaging device”, “Action”: “Send alert
message” },
{ Electronic Device type: “Camera”, “Action”: { “Action 1”: “Record
video”, “Action 2”: “Upload video” }, }, ],}

The JSON rule 402 defines three conditions: the user is not at home (detected using a foot sensor 404), the user is not at home (detected using the location of a smartphone 406 of the homeowner 124) and an intruder is inside the home (detected using a motion sensor 408).

Further, the JSON rule 402 defines three actions: sounding a siren 410, sending an alert to the smartphone 406, and commanding a camera (not shown) to record video and upload the video to a server (for example, the cloud server 118) in the cloud for cloud recording.

The control hub 110 sends an HTTP GET request 412 to the motion sensor 408 and in response, the motion sensor 408 sends the state of the sensor via an HTTP POST request 414. In this embodiment, the HTTP POST request 414 indicates that an intruder 416 is detected in the home 102. Further, the control hub 110 sends an HTTP GET request 418 to the foot sensor 404 and in response, the foot sensor 404 sends the state of the sensor via the HTTP POST request 420. In this embodiment, the HTTP POST request 420 indicates that the homeowner 124 is out of home. Similarly, the control hub 110 sends an HTTP GET request to the smartphone 406 and the smartphone 406 sends the state of the smartphone via an HTTP POST request. In this embodiment, the HTTP POST request indicates that the homeowner 124 is out of home.

The conditions defined in the JSON rule 402 are met. Accordingly, the control hub 110 performs the actions defined in the JSON rule 402. The control hub 110 sends an HTTP POST request 422 to the siren 410 to activate the siren. Further, the control hub 110 sends a message to the smartphone 406. For example, the message may include text “Intruder detected at home. The siren has been activated. Please reach home ASAP. You may watch the video of the intruder here—xyz.com. Thanks.” Further, the control hub 110 sends an HTTP request to the camera (not shown) to initiate recording of a video and then upload the video to a server in the cloud for cloud recording.

In another exemplary embodiment, the present disclosure may provide home health care. The control hub 110 and the user interface 208 enable the caregivers to remotely monitor the condition of a patient. The patient is using one or more electronic medical devices to monitor one or more of blood pressure, heart beat rate, respiration rate and SpO2 (blood oxygen saturation level). The control hub 110 processes the medical data received from the electronic medical devices to predict and detect if the patient at home may be in imminent danger of a heart attack and alert caregivers to take appropriate action. Measures taken based on these early predictions can make significant cut in hospital readmission rate that costs thousands of dollars per day. The threshold values for various parameters like heart beat rate and respiration rate may be preset at the factory but they may be changed by a caregiver through the easy to use user interface. Further, data collected by the control hub 110 may be used for data mining purposes.

Similarly, old people may use a wearable fall detector. When the fall detector predicts/detects that a fall has occurred, the wearer is lying flat on the ground, the wearer is not moving and the panic button is not pushed, then a severe fall is ascertained and an alert is sent to multiple phones. This is accomplished using the chained Boolean algebra module to combine the four conditions: fall has occurred, wearer lying on the ground; wearer not moving and panic button not pushed.

The filtering algorithms (such as non-linear median filtering) may be employed to filter the raw data generated by a triaxial accelerator in the wearable fall detector. The filtering process takes out extraneous noise in the raw signal. Thereafter, the learning algorithms are used to calculate the tilt angle of the wearer to determine the orientation of the wearer (horizontal, vertical, etc.) and energy expenditure level to classify wearer's activity level (motionless, sitting, walking, running, falling, etc.). All the threshold values and median filter window width are first obtained using human simulated fall trials and further refined by actual medical trial using human wearing the fall indicator as they go about their daily activities. More importantly, massive raw data is collected over a period. The data is further analyzed on a cloud server and servers in hospital systems to produce better target threshold values as the product is widely deployed.

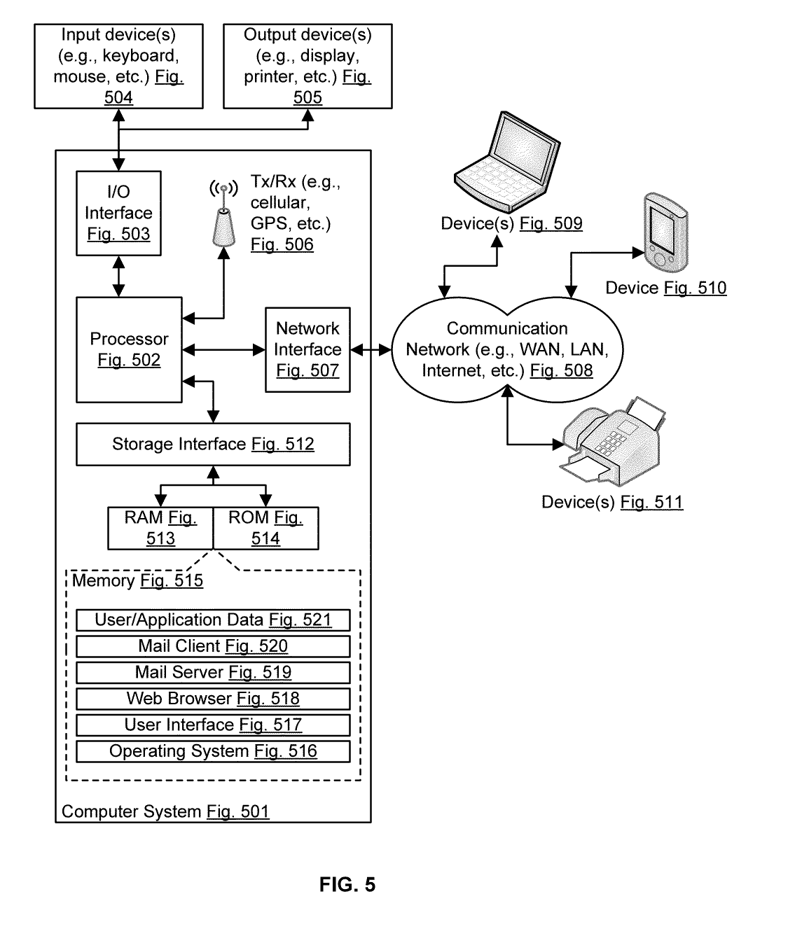

Referring now to FIG. 5, a block diagram of an exemplary computer system 501 for implementing embodiments consistent with the present disclosure is illustrated. Variations of computer system 501 may be used for implementing the control hub 110 and the user interface 208. Computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 515 may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., keywords, requirements, test cases, test scripts, sub requirements, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A system for facilitating automation, the system comprising:
a user interface configured for receiving at least one rule from a user, wherein a rule of the at least one rule comprises at least one condition and at least one action, wherein the at least one condition is based on at least one state of at least one electronic device of a plurality of electronic devices, wherein an electronic device of the plurality of electronic devices comprises at least one of a sensor and an actuator, wherein the at least one action comprises at least one change in a state of an actuator comprised in an electronic device of the plurality of electronic devices; and
a control hub configured for:
receiving the at least one state of the at least one electronic device, wherein the at least one electronic device is configured for communicating with the control hub; and
performing the at least one action based on a result of evaluating the at least one condition.

2. The system of claim 1, wherein the at least one state comprises a plurality of states corresponding to a plurality of time instants, wherein the control hub is further configured for analyzing the plurality of states.

3. The system of claim 1, wherein the at least one condition comprises a plurality of conditions, wherein the at least one condition is based on a Boolean expression comprising the plurality of conditions.

4. The system of claim 2, wherein the control hub is further configured for identifying a set of actions based on analyzing the plurality of states, wherein the user interface is further configured for presenting the set of actions to a user in order to enable the user to select the at least one action from the set of actions corresponding to the at least one condition.

5. The system of claim 4, wherein an action of the at least one action is performed by the user.

6. The system of claim 5, wherein the at least one change in the state of the actuator comprises a plurality of changes, wherein a first set of changes of the plurality of changes corresponds to a first time period and a second set of changes of the plurality of changes corresponds to a second time period, wherein the second set of changes are based on a filtering performed on the first set of changes, wherein the control hub is configured for performing the filtering.

7. The system of claim 1, wherein an electronic device of the at least one electronic device is configured for detecting a presence of a user in a region, wherein the at least one change in the state of the actuator corresponds to an electronic device located in the region.

8. The system of claim 1, wherein an electronic device of the at least one electronic device is configured for monitoring a physiological parameter of a user.

9. The system of claim 1, wherein an electronic device of the at least one electronic device is configured for detecting a falling state of a user.

10. The system of claim 1, wherein the control hub is configured for transmitting a request to the at least one electronic device in order to receive the at least one state of the at least one electronic device.

11. The system of claim 2, wherein analyzing the plurality of states is based on at least one of time series analysis, linear regression, logistic regression, Naive Bayes classification and Supporting Vector Machine classification.

12. The system of claim 1, wherein the at least one state comprises a plurality of states, wherein the control hub is further configured for filtering the plurality of states, wherein the filtering comprises at least one of non-linear median filtering, low pass exponential smoothing filtering, moving average filtering and moving average filtering with non-overlapping window.

13. The system of claim 1, wherein the control hub is further configured for automatically detecting the plurality of electronic devices.

14. The system of claim 1, wherein the plurality of electronic devices are paired with the control hub.

15. The system of claim 14, wherein the control hub automatically maintains connection with the plurality of paired electronic devices.

16. The system of claim 1, wherein the control hub communicates with the at least one electronic device and the user interface via Bluetooth.

17. The system of claim 16, wherein the control hub is one of a class 1 and class 2 Bluetooth device.

18. The system of claim 16 further comprises at least one Bluetooth range extender, wherein the control hub communicates with the at least one electronic device located far away from the control hub, via the at least one Bluetooth range extender.

19. The system of claim 1, wherein the user interface is further configured to allow the user to provide the at least one rule without any coding.

20. A method of facilitating automation, the method comprising:
presenting, with a processor, a user interface configured for receiving at least one rule from a user, wherein a rule of the at least one rule comprises at least one condition and at least one action, wherein the at least one condition is based on at least one state of at least one electronic device of a plurality of electronic devices, wherein an electronic device of the plurality of electronic devices comprises at least one of a sensor and an actuator, wherein the at least one action comprises at least one change in a state of an actuator comprised in an electronic device of the plurality of electronic devices; and
receiving, with the processor, the at least one state of the at least one electronic device; and
performing, with the processor, the at least one action based on a result of evaluating the at least one condition.

21. The method of claim 20, wherein the at least one state comprises a plurality of states corresponding to a plurality of time instants, wherein the method further comprises analyzing, with the processor, the plurality of states.

22. The method of claim 20, wherein the at least one condition comprises a plurality of conditions, wherein the at least one condition is based on a Boolean expression comprising the plurality of conditions.

23. The method of claim 22 further comprising:
identifying, with the processor, a set of actions based on analyzing the plurality of states; and
presenting, with the processor, the set of actions to a user in order to enable the user to select the at least one action from the set of actions corresponding to the at least one condition.

24. The method of claim 23, wherein an action of the at least one action is performed by the user.

25. The method of claim 24, wherein the at least one change in the state of the actuator comprises a plurality of changes, wherein a first set of changes of the plurality of changes corresponds to a first time period and a second set of changes of the plurality of changes corresponds to a second time period, wherein the method further comprises filtering the first set of changes to obtain the second set of changes.

26. The method of claim 20 further comprising detecting a presence of a user in a region, wherein an electronic device of the at least one electronic device is configured for performing the detecting, wherein the at least one change in the state of the actuator corresponds to an electronic device located in the region.

27. The method of claim 20 further comprising monitoring a physiological parameter of a user, wherein an electronic device of the at least one electronic device is configured for performing the monitoring.

28. The method of claim 20 further comprising detecting a falling state of a user, wherein an electronic device of the at least one electronic device is configured for performing the detecting.

29. The method of claim 20 further comprising transmitting, with the processor, a request to the at least one electronic device in order to receive the at least one state of the at least one electronic device.

30. The method of claim 20, wherein analyzing the plurality of states is based on at least one of time series analysis, linear regression, logistic regression, Naive Bayes classification and Supporting Vector Machine classification.

31. The method of claim 20, wherein the at least one state comprises a plurality of states, wherein the method further comprises filtering, with a processor, the plurality of states, wherein the filtering comprises at least one of non-linear median filtering, low pass exponential smoothing filtering, moving average filtering and moving average filtering with non-overlapping window.

32. The method of claim 20 further comprising automatically detecting, with the processor, the plurality of electronic devices.

33. The method of claim 20, further comprising pairing, via the processor, the plurality of electronic devices with the processor.

34. The system of claim 33, wherein the processor automatically maintains connection with the plurality of paired electronic devices.

35. The method of claim 20, wherein the processor communicates with the at least one electronic device via a Bluetooth connection.

36. The method of claim 20, wherein the user interface is further configured to allow the user to provide the at least one rule without any coding.
